(19) United States
(12) Patent Application Publication
(10) Pub. No.: US 2007/0076991 A1
(43) Pub. Date: Apr. 5, 2007

(54) HYDRODYNAMIC BEARING ASSEMBLY

(76) Inventors: Ching-Hsing Huang, Shenzhen (CN); Chien-Long Hong, Shenzhen (CN); Wun-Chang Shih, Shenzhen (CN); Hsien-Sheng Pei, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,912

(22) Filed: May 25, 2006

(30) Foreign Application Priority Data
Sep. 30, 2005 (CN) 200510100071.X

(51) Int. Cl. H02K 5/16; F16C 32/06

(52) U.S. Cl. 384/107; 310/90

(57) ABSTRACT

A hydrodynamic bearing assembly (30) includes a bearing sleeve (10) defining at least an open end therein (14); a shaft (20) rotatably disposed in the bearing sleeve; lubricant (40) filled in a bearing clearance (11) formed between an outer face (21) of the shaft and an inner face (12) of the bearing sleeve; and a leakage-preventing band disposed at the open end of the bearing sleeve. An outer face of the shaft defines a plurality of lubricant pressure generating grooves (17) straightly along an axial direction thereof for generation of hydrodynamic pressure of the lubricant. Each groove has a depth gradually decreased along a rotation direction of the shaft.

### FIELD OF THE INVENTION

The present invention relates generally to bearing assemblies, and more particularly to a bearing assembly of hydrodynamic type.

### DESCRIPTION OF RELATED ART

Due to the ever growing demand for quiet, low-friction rotational elements with extended lifetimes, hydrodynamic bearing assemblies have become increasingly used in conventional motors such as fan motors or HDDs (Hard Disk Drives) motors.

A typical hydrodynamic bearing assembly comprises a bearing which defines a bearing hole therein, and a shaft rotatably received in the bearing hole with a bearing clearance formed between an inner surface of the bearing and an outer surface of the shaft. The bearing clearance is filled with lubricating oil. Hydrodynamic pressure generating grooves of so-called herringbone type are provided in either the inner surface of the bearing or the outer surface of the shaft. Each of such grooves is V-shaped, and has first and second branches extend along different directions from ends of the bearing toward central areas thereof. The first branches and respective second branches intercross at the central areas of the grooves. Once the rotary shaft rotates, the lubricating oil is driven from the ends of the bearing toward the central areas to generate hydrodynamic pressure, which supports the shaft without direct contact between the shaft and the bearing.

In manufacturing the grooves, a tooling head is needed to extend into the bearing hole to carve the grooves on the inner surface of the bearing. However, the first and second branches of the herringbone type grooves extend along different directions. So the direction of the tooling head needs to be changed in the manufacture of the grooves, which is difficult to be accomplished due to the small size of the bearing. This makes the grooves be complicated to manufacture. So, there is a need for a hydrodynamic bearing assembly with grooves, which can easily be manufactured and enables to generate satisfied hydrodynamic pressure.

### SUMMARY OF INVENTION

The present invention relates to a hydrodynamic bearing assembly for a motor such as a fan motor or a HDD motor. According to a preferred embodiment of the present invention, the hydrodynamic bearing assembly includes a bearing sleeve with at least an end thereof being opened; a shaft rotatably disposed in the bearing sleeve; lubricant filled a bearing clearance formed between an outer face of the shaft and an inner face of the bearing sleeve; and a leakage-preventing band disposed at the open end of the bearing sleeve. The leakage-preventing band is formed by a tapered surface of the bearing sleeve at the open end, wherein the tapered surface faces the shaft and flares out toward the open end. One of the inner face of the bearing sleeve and the outer face of the shaft defines a plurality of lubricant pressure generating grooves straightly along an axial direction thereof for generation of hydrodynamic pressure. Each of the grooves has a depth gradually decreased along a rotation direction of the shaft.

Other advantages and novel features of the present invention will become more apparent from the following detailed description of preferred embodiment when taken in conjunction with the accompanying drawings, in which:

### BRIEF DESCRIPTION OF DRAWINGS

FIG. 1 is an assembled view of a hydrodynamic bearing assembly according to a preferred embodiment of the present invention;

FIG. 2 is a sectional view of a bearing sleeve shown in FIG. 1, taken along the line II-II;

FIG. 3 is a longitudinal sectional view of the hydrodynamic bearing assembly of FIG. 1;

FIG. 4 is an enlarged view of a circled portion of FIG. 4 indicated by IV; and

FIG. 5 is a cross sectional view of the hydrodynamic bearing assembly of FIG. 1.

### DETAILED DESCRIPTION

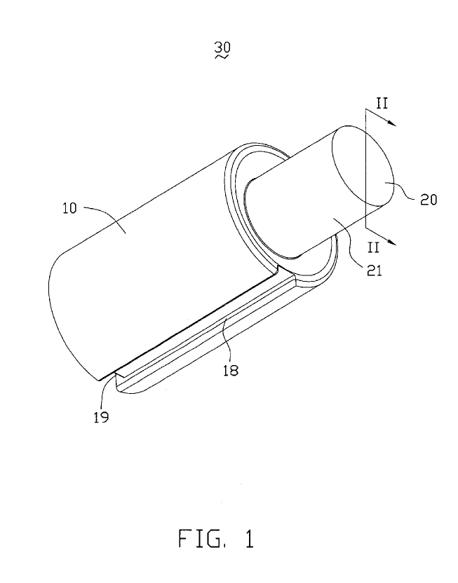

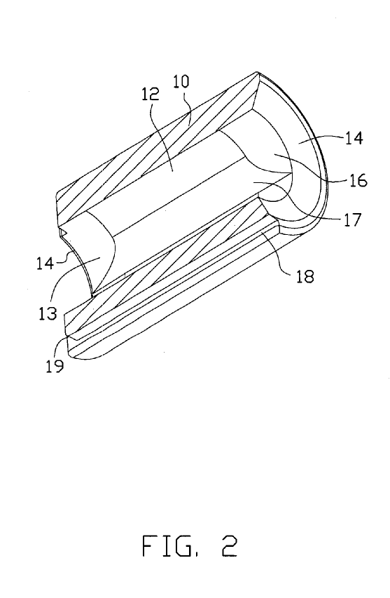

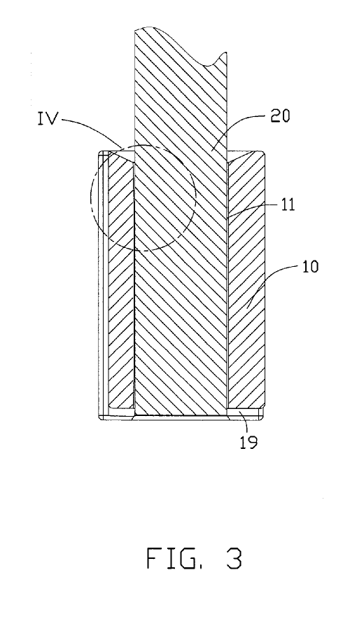

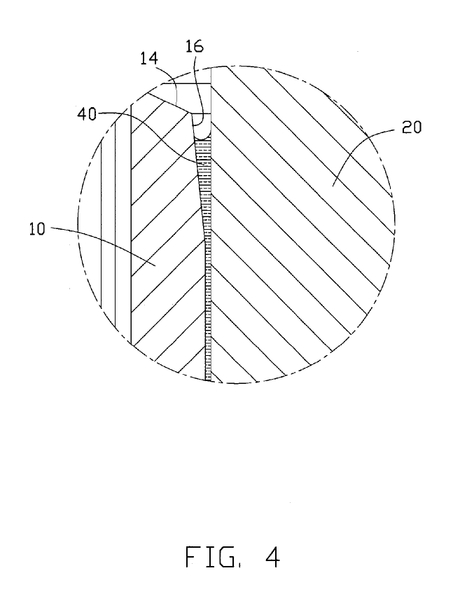

Referring to FIGS. 1 and 2, a hydrodynamic bearing assembly 30 according to a preferred embodiment of the present invention is shown. The bearing assembly 30 includes a bearing sleeve 10 and a shaft 20 rotatably received in the bearing sleeve 10. The bearing sleeve 10 and the shaft 20 are made of ceramic or metallic materials. A bearing clearance 11 (shown in FIG. 3) is formed between an inner face 12 of the bearing sleeve 10 and an outer face 21 of the shaft 20. Lubricant 40 (shown in FIG. 4) is received in the bearing clearance 11 for generation of hydrodynamic pressure, which supports the shaft 20 without radial contact between the shaft 20 and the bearing sleeve 10.

Particularly referring to FIGS. 2, 3 and 4, the bearing sleeve 10 defines a bearing hole 13 therethrough, for receiving the shaft 20 therein. Two open ends 14 are formed at ends of the bearing sleeve 10, with two tapered surfaces 16 formed thereat. A radial distance between the inner face 12 of the bearing sleeve 10 and the outer face 21 of the shaft 20 is gradually increased from an inner end of each tapered surface 16 toward the respective open end 14 of the bearing sleeve 10. So the bearing sleeve 10 at the open ends 14 has a larger space than that at the inner ends of the tapered surfaces 16. The distance is tiny with a range from 20 μm to 300 μm. A capillary force is formed between the inner face 12 of the bearing sleeve 10 and the outer face 21 of the shaft 20. When the lubricant 40 moves from the inner ends of the tapered surfaces 16 toward the open ends 14 of the bearing assembly 30, the pressure of the lubricant 40 decreases lower than the capillary force. The lubricant 40 at the open ends 14 of the bearing assembly 30 is kept thereat by the capillary force. This prevents the lubricant 40 from leakage from the open ends 14 of the bearing sleeve 10. Two leakage-preventing bands are thereby formed at the open ends 14 of the bearing sleeve 10.

Sequentially referring to FIG. 2, the bearing sleeve 10 defines a plurality of lubricant pressure generating grooves 17 in the inner face 12 thereof. The lubricant pressure generating grooves 17 extend through the bearing sleeve 10 straightly along an axial direction thereof. First and second channels 18, 19 are respectively defined along an axial direction of an outer face 21 of the bearing sleeve 10 and a radial direction of a bottom face of the bearing sleeve 10. The second channel 19 communicates with the first channel 18 at one end thereof, for benefiting air retained in the bearing sleeve 10 to leave therefrom as the shaft 20 is inserted into the bearing hole 13 of the bearing sleeve 10.

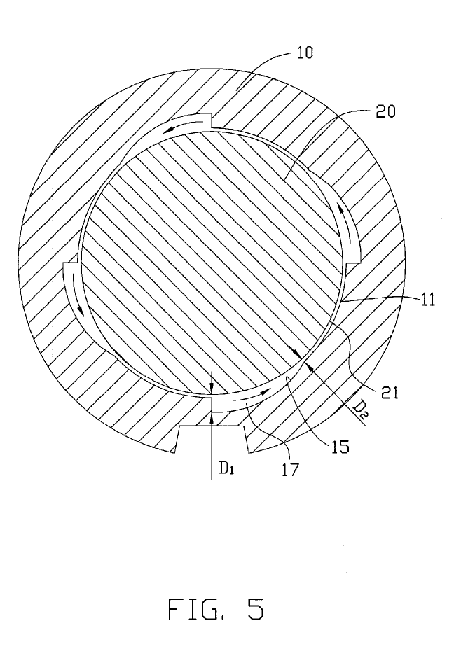

Particularly referring to FIG. 5, a cross sectional view of the bearing assembly 30 is shown. In order to show the lubricant pressure generating grooves 17 of the bearing sleeve 10 clearly, the lubricant 40 filled in the bearing clearance 11 is removed. Viewed from FIG. 5, the bearing sleeve 10 has four lubricant pressure generating grooves 17, which are evenly distribute around a periphery of the inner face 12 of the bearing sleeve 10. The inner face 12 of the bearing sleeve 10 forms an arc portion 15 at each of the lubricant pressure generating grooves 17. A radial distance between each of the arc portions 15 and the outer face 21 of the shaft 20 is gradually decreased along a rotation direction of the shaft 20. In other words, the lubricant pressure generating groove 17 has a depth gradually decreased along the rotation direction of the shaft 20. A first radial distance D1 is thereby formed at a front end of the lubricant pressure generating groove 17, which is greater than a second radial distance D2 formed at a rear end of the lubricant pressure generating groove 17. Upon rotating of the shaft 20, the lubricant 40 at the first radial distance D1 of the bearing assembly 30 is pushed toward the second radial distance D2 thereof. That is, the lubricant 40 is driven from a larger space toward a smaller space. The hydrodynamic pressure is therefore established and supports the shaft 20 without radial contact between the shaft 20 and the bearing sleeve 10.

In the present invention, the lubricant pressure generating grooves 17 extend along the axial direction of the bearing sleeve 10. So the direction of a tooling head may not be changed during the manufacture of the lubricant pressure generating grooves 17. This makes the lubricant pressure generating grooves 17 be simply carved on the inner face 12 of the bearing sleeve 10 as compared to the manufacture of the herringbone shaped lubricant pressure generating grooves. Moreover, this makes the lubricant pressure generating grooves 17 be easily formed by sintered manner, because a mold of the bearing sleeve 10 can easily be moved away therefrom. In addition, the tapered surfaces 16 of the bearing sleeve 10 prevent the lubricant 40 from leakage from the open ends 14 of the bearing sleeve 10, which increases the life of the bearing assembly 30.

In the present invention, the tapered surfaces 16 are formed at two ends of the bearing sleeve 10. Alternatively, there can be only one tapered surface 16 formed at one end of the bearing sleeve 10. The lubricant pressure generating grooves 17 may either be defined in the outer face 21 of the shaft 20.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hydrodynamic bearing assembly comprising:
a bearing sleeve with at least an end thereof being opened;
a shaft rotatably disposed in the bearing sleeve;
lubricant filled in a bearing clearance formed between an outer face of the shaft and an inner face of the bearing sleeve; and
a leakage-preventing band disposed at the open end of the bearing sleeve;
wherein one of the inner face of the bearing sleeve and the outer face of the shaft defines a plurality of lubricant pressure generating grooves straightly along an axial direction thereof for generation of hydrodynamic pressure of the lubricant when the shaft is rotated relative to the bearing sleeve.

2. The hydrodynamic bearing assembly as described in claim 1, wherein the bearing sleeve defines a tapered surface at the leakage-preventing band for preventing the lubricant from leakage.

3. The hydrodynamic bearing assembly as described in claim 2, wherein a radial distance between the inner face of the bearing sleeve and the outer face of the shaft is gradually increased from an inner end of the tapered surface toward the open end of the bearing sleeve.

4. The hydrodynamic bearing assembly as described in claim 1, wherein the lubricant pressure generating grooves are evenly distributed around the one of the inner face of the bearing sleeve and the outer face of the shaft.

5. The hydrodynamic bearing assembly as described in claim 1, wherein a depth of each lubricant pressure generating groove is gradually decreased along a rotation direction of the shaft.

6. The hydrodynamic bearing assembly as described in claim 1, wherein the lubricant pressure generating grooves extend through the bearing sleeve straightly along the axial direction thereof.

7. The hydrodynamic bearing assembly as described in claim 1, wherein the bearing sleeve defines first and second channels therein for benefiting air retained in the bearing sleeve to leave therefrom.

8. The hydrodynamic bearing assembly as described in claim 1, wherein the shaft is made of ceramic material.

9. The hydrodynamic bearing assembly as described in claim 1, wherein the bearing sleeve is made of ceramic material.

10. A hydrodynamic bearing assembly comprising:
a bearing sleeve defining a plurality of lubricant pressure generating grooves distributed around an inner face thereof;
a shaft rotatably received in the bearing sleeve; and
lubricant filled in a bearing clearance formed between an outer face of the shaft and the inner face of the bearing sleeve;
wherein the bearing sleeve at each of the lubricant pressure generating grooves forms a greater and a smaller radial distance with the outer face of the shaft, the lubricant moves from the greater radial distance toward the smaller radial distance to generate lubricant pressure when the shaft is rotated relative to the bearing sleeve.

11. The hydrodynamic bearing assembly as described in claim 10, wherein the bearing sleeve defines at least an open end therein, a radial distance between the inner face of the bearing sleeve and the outer face of the shaft is gradually increased from a middle portion of the bearing sleeve toward the open end thereof.

12. The hydrodynamic bearing assembly as described in claim 11, wherein the distance between the inner face of the bearing sleeve and the outer face of the shaft has a range from 20 μm to 300 μm.

13. The hydrodynamic bearing assembly as described in claim 10, wherein the bearing sleeve forms an arc portion at each of the lubricant pressure generating grooves, a radial distance between each of the arc portions and the outer face of the shaft is gradually decreased along a rotation direction of the shaft.

14. The hydrodynamic bearing assembly as described in claim 10, wherein the lubricant pressure generating grooves extend along an axial direction of the bearing sleeve.

15. The hydrodynamic bearing assembly as described in claim 10, wherein the lubricant pressure generating grooves extends through the bearing sleeve straightly along an axial direction thereof.

16. The hydrodynamic bearing assembly as described in claim 10, wherein the bearing sleeve and the shaft are made of ceramic materials.

17. A hydrodynamic bearing assembly comprising:
a bearing sleeve having a bearing hole;
a shaft rotatably mounted in the bearing hole of the bearing sleeve; and
lubricant filled in the bearing hole between the bearing sleeve and the shaft;
wherein the bearing hole of the bearing sleeve has at least an open end and a tapered surface facing the shaft and flaring out toward the at least an open end, and wherein the shaft has grooves in an outer surface thereof, the grooves extend straightly along an axial direction of the shaft and each have a depth gradually decreased along a rotation direction of the shaft.

18. The bearing assembly as described in claim 17, wherein first and second channels are respectively defined along an axial direction of an outer face of the bearing sleeve and a radial direction of a bottom face of the bearing sleeve, the first and second channels communicating with each other whereby air in the bearing hole can leave the bearing hole of the bearing sleeve through the channels when the shaft is mounted in the bearing hole.
